(19) United States
(12) Patent Application Publication
(10) Pub. No.: US 2016/0037900 A1
(43) Pub. Date: Feb. 11, 2016

(54) BRUSH ASSEMBLY AND METHOD FOR BLOCKING DEBRIS

(71) Applicant: Dale Manor, Farmington Hills, MI (US)

(72) Inventor: Dale Manor, Farmington Hills, MI (US)

(21) Appl. No.: 14/813,327

(22) Filed: Jul. 30, 2015

Related U.S. Application Data
(60) Provisional application No. 62/033,703, filed on Aug. 6, 2014.

(51) Int. Cl. A46B 5/00; B25J 15/00

(52) U.S. Cl. CPC A46B 5/0095; B25J 15/0019; Y10S 901/42

(57) ABSTRACT

A brush assembly is provided. The brush assembly includes an extruded mounting bracket having first and second substantially U-shaped bracket portions defining first and second channels, respectively, therein. The brush assembly further includes a first plurality of bristles that are at least partially disposed in the first channel of the first substantially U-shaped bracket portion such that the first plurality of bristles are coupled to the first substantially U-shaped bracket portion. The brush assembly further includes a second plurality of bristles that are at least partially disposed in the second channel of the second substantially U-shaped bracket portion such that the second plurality of bristles are coupled to the second substantially U-shaped bracket portion.

### CROSS-REFERENCE TO RELATED APPLICATIONS

This application claims priority to U.S. Provisional Patent Application No. 62/033,703 filed on Aug. 6, 2014, the entire contents of which are hereby incorporated by reference herein.

### BACKGROUND

Welding tool devices utilize copper electrodes. The welding tools are periodically cleaned to remove debris from the copper electrodes. During this cleaning process, the debris includes a substantial amount of copper from the copper electrodes that is undesirably deposited on a manufacturing floor. Since the copper is a relatively valuable metal, an operator typically sweeps up the debris utilizing a broom and deposits the debris in a collection bin. A drawback with this cleaning process is that a relatively large amount of labor is utilized to collect the debris having the copper therein from the manufacturing floor.

Accordingly, the inventor herein has recognized a need for an improved method of blocking debris that minimizes and/or eliminates the above-mentioned deficiencies.

### SUMMARY

A brush assembly in accordance with an exemplary embodiment is provided. The brush assembly includes an extruded mounting bracket having first and second substantially U-shaped bracket portions integrally coupled together along an entire length of the extruded mounting bracket. The first and second substantially U-shaped bracket portions define first and second channels, respectively, therein. The first substantially U-shaped bracket portion has a first cross-sectional profile that is centered about a first axis at a first position on the extruded mounting bracket. The second substantially U-shaped bracket portion has a second cross-sectional profile that is centered about a second axis at the first position on the extruded mounting bracket. The second axis is disposed at an acute angle relative to the first axis. An open end of the first substantially U-shaped bracket portion is disposed distal from an open end of the second substantially U-shaped bracket portion. The extruded mounting bracket is shaped to have an arcuate-shaped channel portion and first and second leg portions. Each of the arcuate-shaped channel portion and the first and second leg portions have the first and second substantially U-shaped bracket portions. The arcuate-shaped channel portion has a first end and a second end. The first leg portion is integrally coupled to and extends from the first end of the arcuate-shaped channel portion. The second leg portion is integrally coupled to and extending from the second end of the arcuate-shaped channel portion. The brush assembly further includes a first plurality of bristles that are at least partially disposed in the first channel of the first substantially U-shaped bracket portion such that the first plurality of bristles are coupled to the first substantially U-shaped bracket portion. The first plurality of bristles extending outwardly from the first substantially U-shaped bracket portion in a direction substantially parallel to the first axis. The brush assembly further includes a second plurality of bristles that are at least partially disposed in the second channel of the second substantially U-shaped bracket portion such that the second plurality of bristles are coupled to the second substantially U-shaped bracket portion. The second plurality of bristles extend outwardly from the second substantially U-shaped bracket portion in a direction substantially parallel to the second axis.

A method for blocking debris from a welding tool in accordance with another exemplary embodiment is provided. The method includes providing a brush assembly having an extruded mounting bracket, a first plurality of bristles, and a second plurality of bristles. The extruded mounting bracket defines first and second substantially U-shaped bracket portions integrally coupled together along a length of the extruded mounting bracket. The first and second substantially U-shaped bracket portions define first and second channels, respectively, therein. The first substantially U-shaped bracket portion has a first cross-sectional profile that is centered about a first axis at a first position on the extruded mounting bracket. The second substantially U-shaped bracket portion has a second cross-sectional profile that is centered about a second axis at the first position on the extruded mounting bracket. The second axis is disposed at an acute angle relative to the first axis. An open end of the first substantially U-shaped bracket portion is disposed distal from an open end of the second substantially U-shaped bracket portion. The extruded mounting bracket is shaped to have an arcuate-shaped channel portion and first and second leg portions. Each of the arcuate-shaped channel portion and the first and second leg portions have the first and second substantially U-shaped bracket portions. The arcuate-shaped channel portion has a first end and a second end. The first leg portion is integrally coupled to and extends from the first end of the arcuate-shaped channel portion. The second leg is integrally coupled to and extends from the second end of the arcuate-shaped channel portion. The first plurality of bristles are at least partially disposed in the first channel of the first substantially U-shaped bracket portion such that the first plurality of bristles are coupled to the first substantially U-shaped bracket portion. The first plurality of bristles extend outwardly from the first substantially U-shaped bracket portion in a direction substantially parallel to the first axis. The second plurality of bristles are at least partially disposed in the second channel of the second substantially U-shaped bracket portion such that the second plurality of bristles are coupled to the second substantially U-shaped bracket portion. The second plurality of bristles extend outwardly from the second substantially U-shaped bracket portion in a direction substantially parallel to the second axis. The first and second plurality of bristles define an interior region. The method further includes blocking debris removed from the welding tool from moving outwardly past the first and second plurality of bristles utilizing the first and second plurality of bristles, and directing the debris downwardly from the brush assembly utilizing the first and second plurality of bristles.

These and other advantages and features will become more apparent from the following description taken in conjunction with the drawings.

### BRIEF DESCRIPTION OF THE DRAWINGS

FIG. 1 is schematic of a debris collection assembly in accordance with an exemplary embodiment;

FIG. 2 is a side view of the debris collection assembly of FIG. 1;

FIG. 3 is a front view of the debris collection assembly of FIG. 1;

FIG. 4 is an exploded view of a portion of the debris collection assembly of

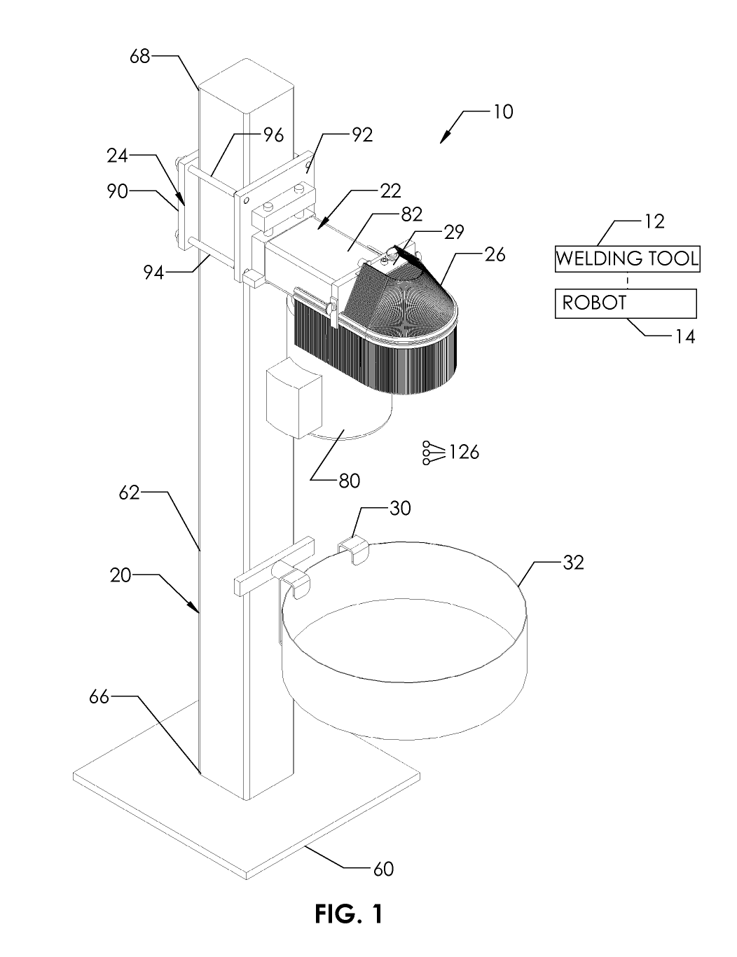

FIG. 1;

FIG. 5 is an isometric view of a brush assembly in accordance with another exemplary embodiment, and a retaining bracket utilized in the debris collection assembly of FIG. 1;

FIG. 6 is an isometric view of the brush assembly and the retaining bracket of FIG. 5, and a brush utilized in the debris collection assembly of FIG. 1;

FIG. 7 is a cross-sectional view of the brush assembly and the mounting bracket of FIG. 5;

FIG. 8 is a side view of the brush assembly and the mounting bracket of FIG. 5;

FIG. 9 is an isometric view of the brush assembly of FIG. 5;

FIG. 10 is a front view of the brush assembly of FIG. 5;

FIG. 11 is a cross-sectional view of the brush assembly of FIG. 5;

FIG. 12 is a cross-sectional view of an extruded mounting bracket utilized in the brush assembly of FIG. 5;

FIG. 13 is an isometric view of the extruded mounting bracket of FIG. 12;

FIG. 14 is another isometric view of the extruded mounting bracket of FIG. 12;

FIG. 15 is a top view of the brush assembly of FIG. 5;

FIG. 16 is an isometric view of the retaining bracket utilized in the debris collection assembly of FIG. 1;

FIG. 17 is a cross-sectional view of the retainer bracket of FIG. 16; and

FIG. 18-19 are flowcharts of a method for collecting debris from a welding tool in accordance with another exemplary embodiment.

### DETAILED DESCRIPTION

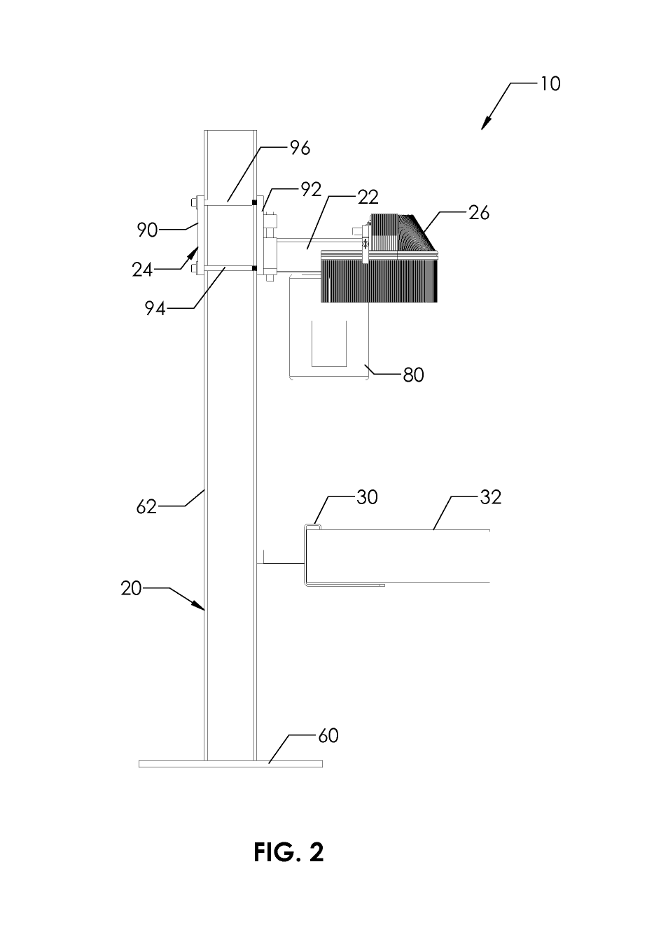

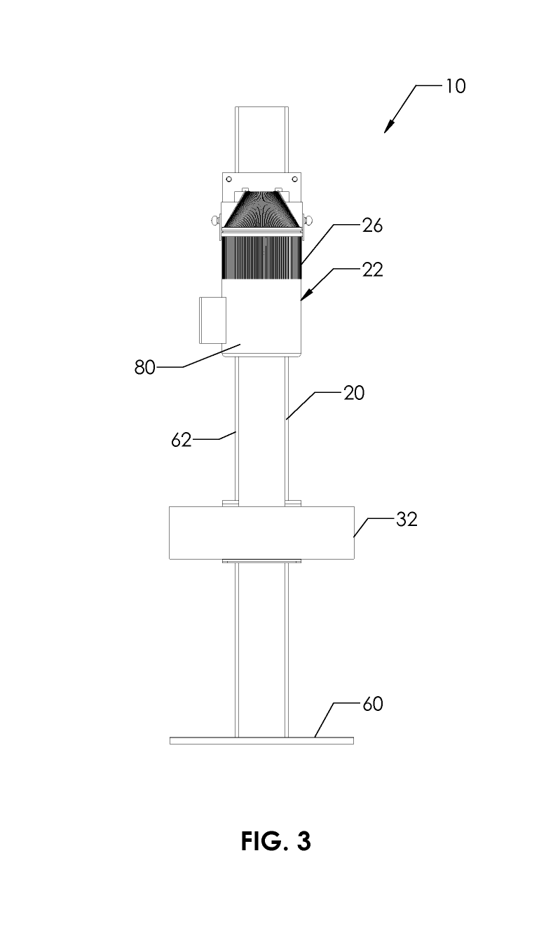

Referring to FIGS. 1-4, a debris collection assembly 10 in accordance with an exemplary embodiment for capturing debris from a welding tool 12 is illustrated. A robot 14 is provided to position the welding tool 12 within the debris collection assembly 10 such that the welding tool 12 is cleaned by a debris removal assembly 22. The debris collection assembly 10 is configured to direct debris having copper particles removed from the welding tool 12 into a collection container 32. The debris collection assembly 10 includes a mounting stand 20, the debris removal assembly 22, an attachment bracket 24, a brush assembly 26, retaining bracket assembly 28, a brush 29, a container coupling member 30, and the collection container 32.

The mounting stand 20 is provided to support the remaining components of the debris collection assembly 10. The mounting stand 20 includes a base plate 60 and a post 62. The post 62 includes a first end 66 in the second end 68. The first end 66 is disposed on and is coupled to a top surface of the base plate 60. Also, the post 62 extends substantially perpendicular to the base plate 60. In an exemplary embodiment, the mounting stand 20 is constructed of steel.

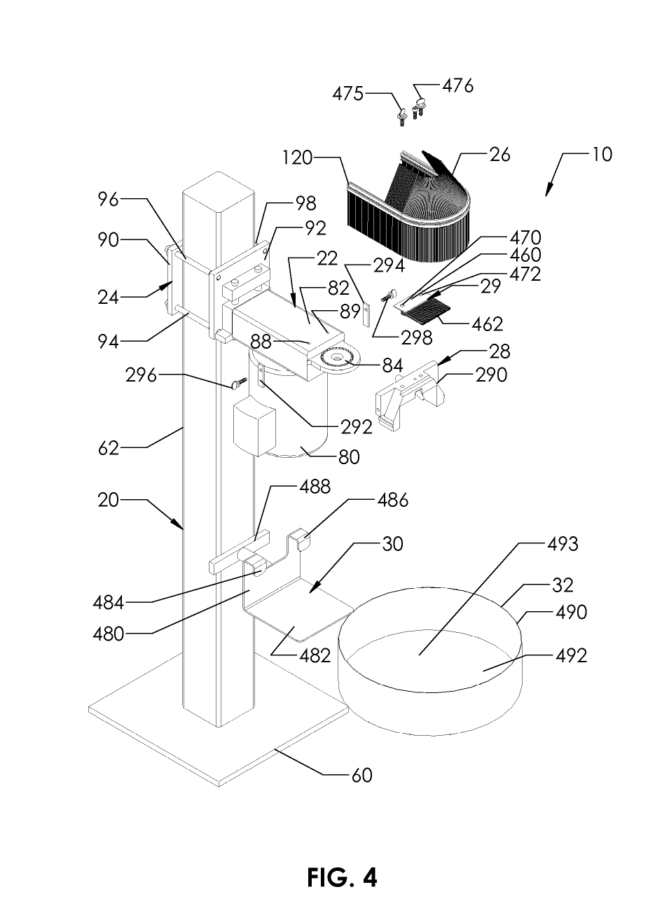

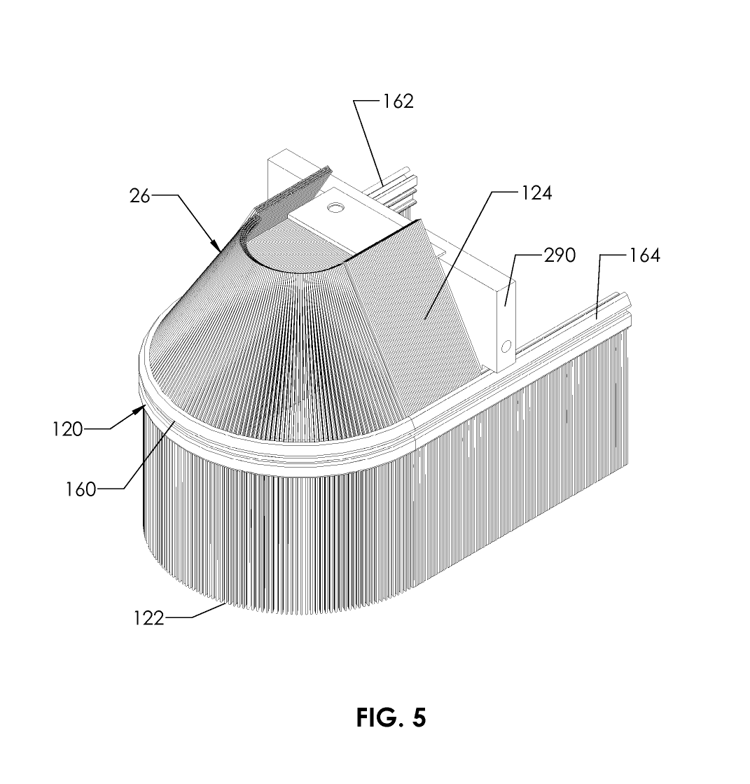

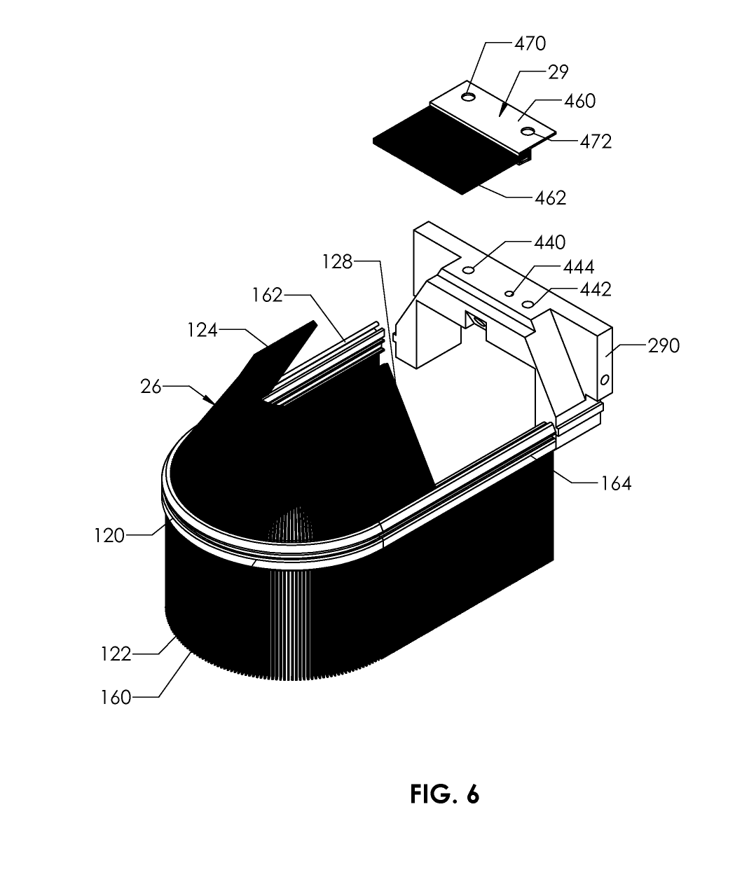

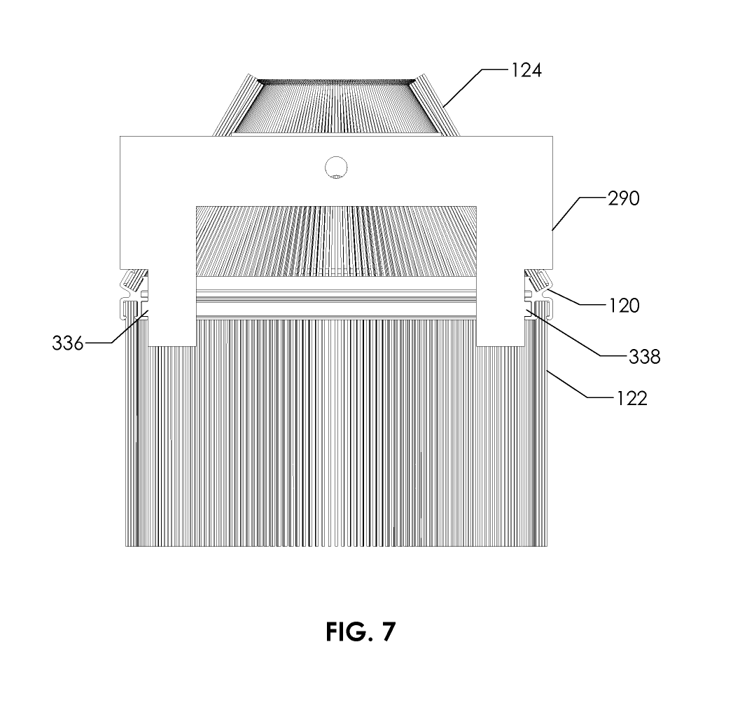

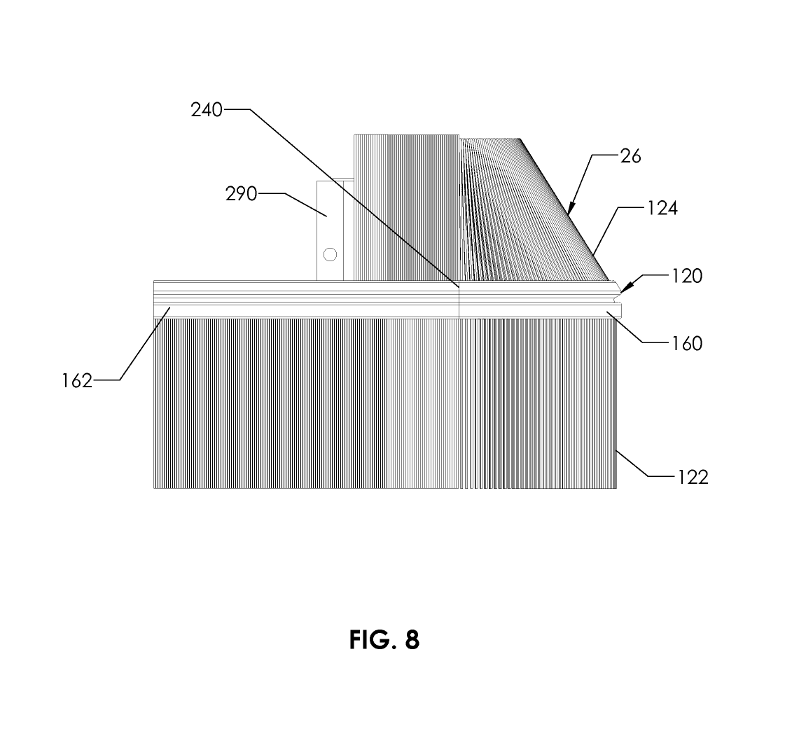

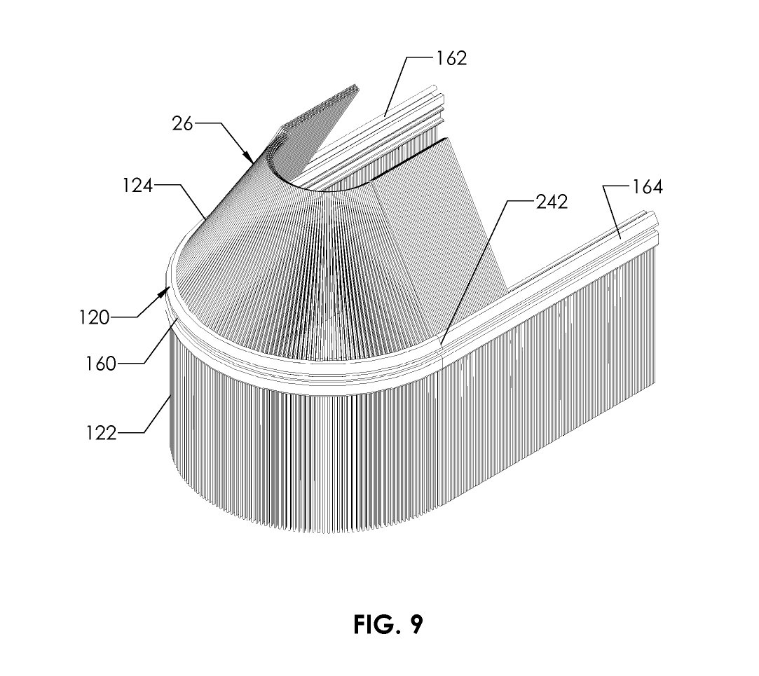

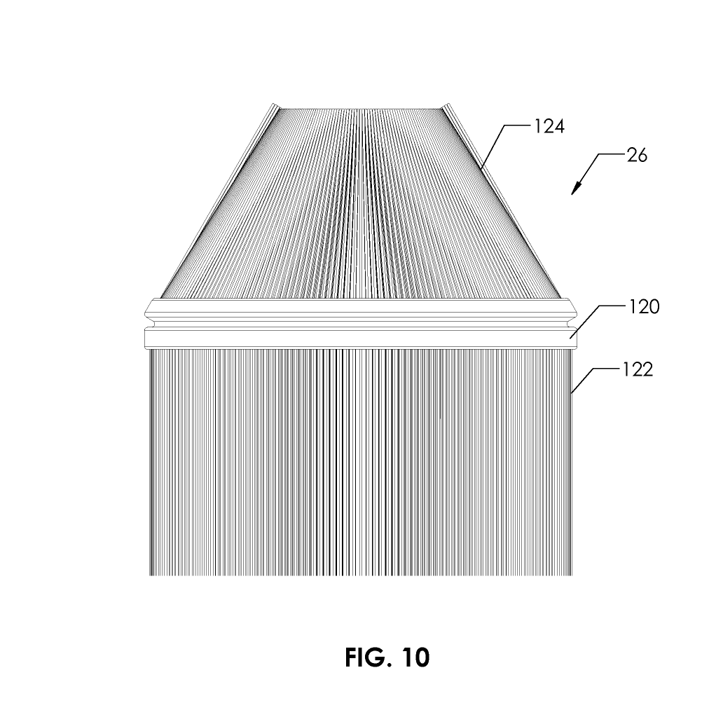

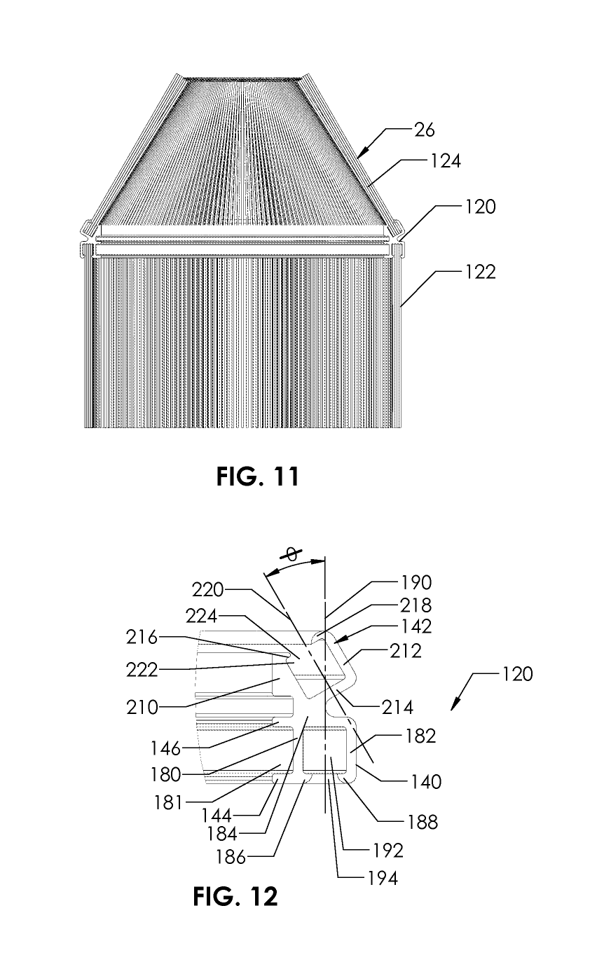

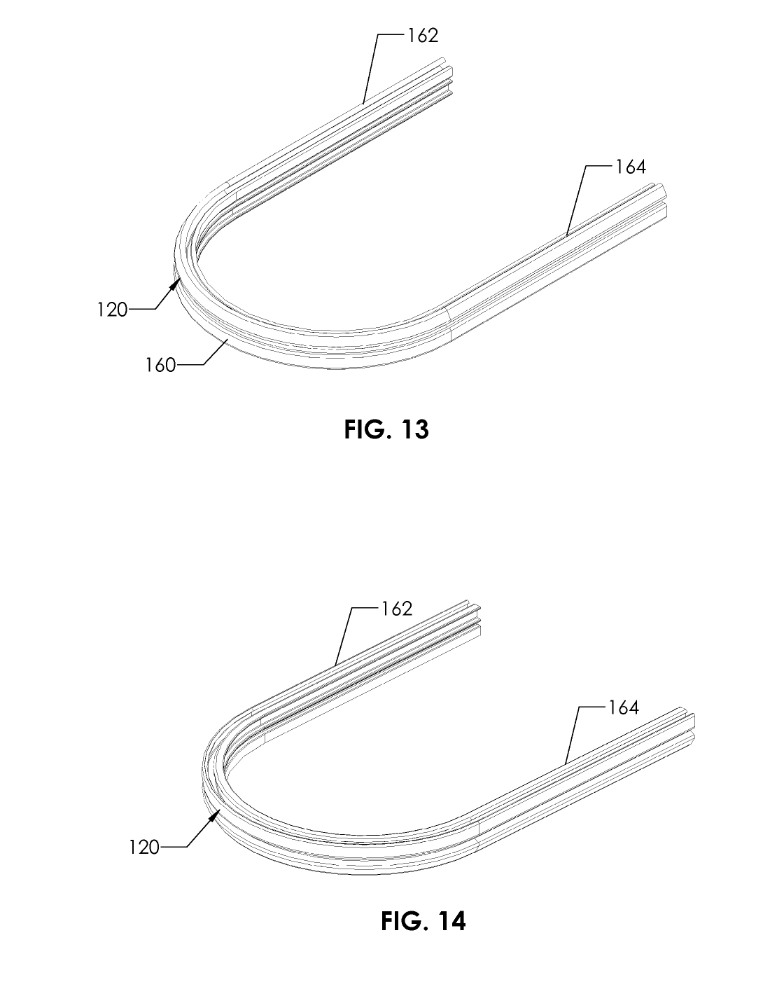

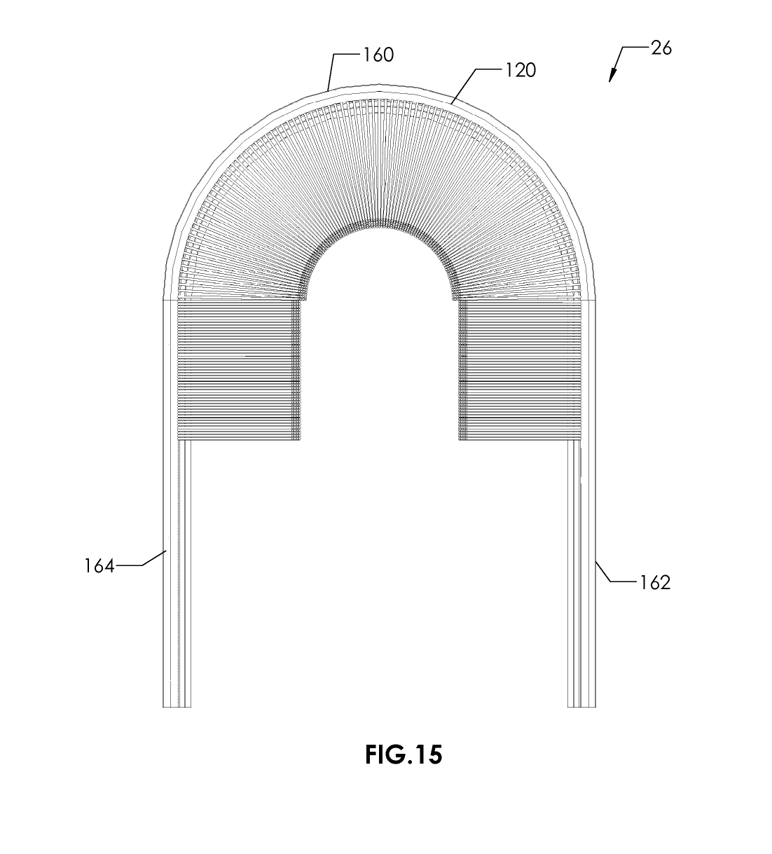

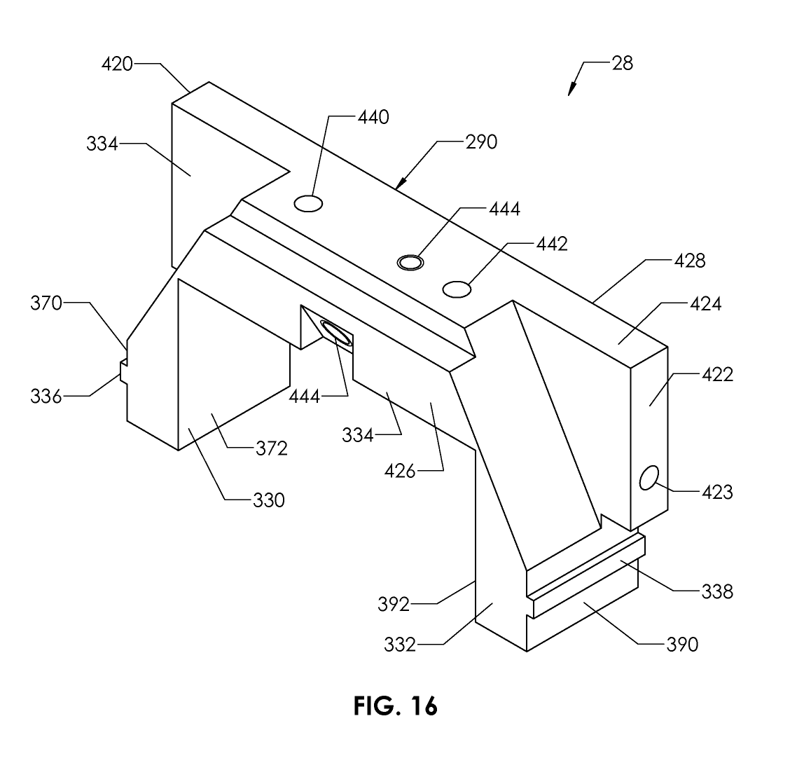

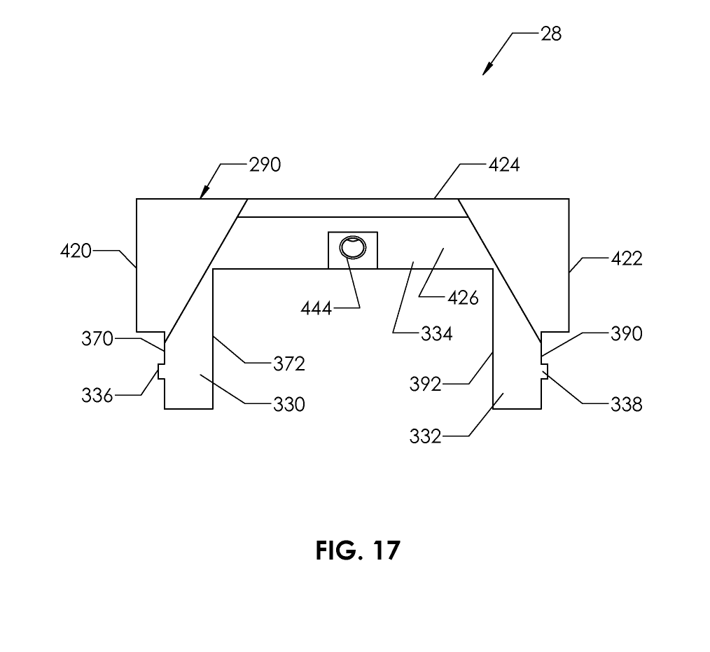

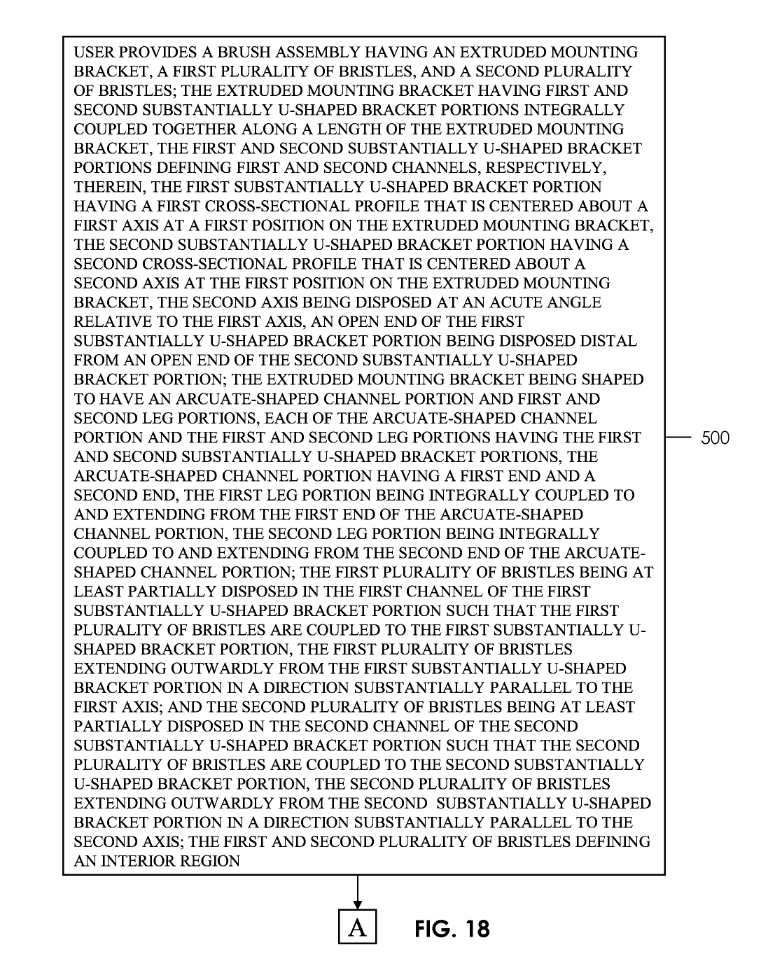

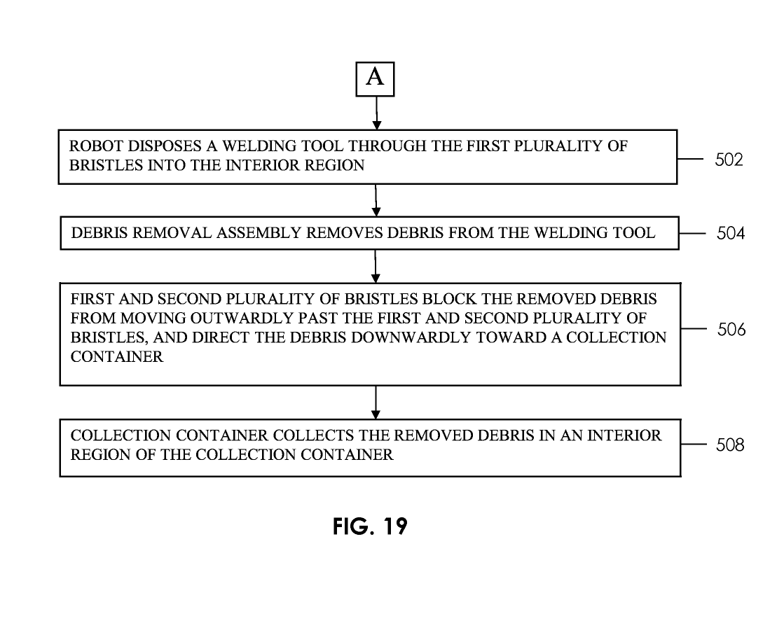

Referring to FIGS. 1 and 4, the debris removal assembly 22 is provided to remove debris from the welding tool 12. The debris removal assembly 22 includes an electric motor 80, a gear box 82, and a rotatable cleaning tool 84. The gear box 82 is coupled to the post 62 utilizing the attachment bracket 24. The gear box 82 extends substantially perpendicular to the post 62 and includes apertures 88, 89 extending therein. The gear box 82 is operably coupled to the rotatable cleaning tool 84. In particular, internal gears within the gear box 82 are operably coupled to the rotatable cleaning tool 84. The electric motor 80 rotates the internal gears within the gear box 82 which further rotate the rotatable cleaning tool 84. The rotatable cleaning tool 84 removes debris from the welding tool 12 when the welding tool 12 is disposed against the rotatable cleaning tool 84.

The attachment bracket 24 is provided to couple the debris removal assembly 22 to the post 62. The attachment bracket 24 includes plates 90, 92 and bolts 94, 96, 98. The plates 90, 92 are disposed on first and second sides, respectively of the post 62. The bolts 94, 96 are disposed adjacent to a third side of the post 62 and extend through the plates 90, 92 to couple the plates 90, 92 to one another. The bolt 98 is disposed adjacent to a fourth side of the post 62 extends through the plates 90, 92 to couple the plates 90, 92 to one another. The gear box 82 is fixedly attached to the plate 92.

Referring to FIGS. 1 and 5-15, the brush assembly 26 is provided to block debris 126 having copper particles from moving outwardly from the brush assembly 26 and to direct the debris 126 having the copper particles into the collection container 32. The brush assembly 26 includes extruded mounting bracket 120, a first plurality of bristles 122, and a second plurality of bristles 124.

Referring to FIGS. 5 and 12, the extruded mounting bracket 120 is provided to hold the first plurality bristles 122 and the second plurality of bristles 124 thereon. The extruded mounting bracket 120 includes a first substantially U-shaped bracket portion 140, a second substantially U-shaped bracket portion 142, a first positioning tab 144, and a second positioning tab 146. In an exemplary embodiment, the extruded mounting bracket 120 is constructed of galvanized steel. However, in an alternative embodiment, the extruded mounting bracket 120 could be constructed of other materials such as stainless steel or plastic for example.

The first and second substantially U-shaped bracket portions 140, 142 are integrally coupled together along an entire length of the extruded mounting bracket 120. Another name for the U-shaped bracket portions 140, 142 are yoke portions 140, 142, respectively. The first and second substantially U-shaped bracket portions 140, 142 define first and second channels 192, 224, respectively, therein. The first substantially U-shaped bracket portion 140 has a first cross-sectional profile that is centered about a first axis 90 at a first position on the extruded mounting bracket 120. The second substantially U-shaped bracket portion 142 has a second cross-sectional profile that is centered about a second axis 220 at the first position on the extruded mounting bracket 120. The second axis 220 is disposed at an acute angle 0 relative to the first axis 190. An open end of the first substantially U-shaped bracket portion 140 is disposed distal from an open end of the second substantially U-shaped bracket portion 142.

The structure of the first substantially U-shaped bracket portion 140 will now be described in greater detail. The first substantially U-shaped bracket portion 140 includes first, second, and third wall portions 180, 182, 184 and first and second tab portions 186, 188. The first and second wall portions 180, 182 extend substantially parallel to the first axis 190 and are spaced apart from one another. The third wall portion 184 is coupled to and extends between a first end of the first wall portion 180 and a first end of the second wall portion 182. The first tab portion 186 extends from a second end of the first wall portion 180 substantially perpendicular to the first wall portion 180 and toward the second wall portion 182. The second tab portion 188 extends from a second end of the second wall portion 182 substantially perpendicular to the second wall portion 182 and toward the first wall portion 180 such that a first gap 194 is formed between the first and second tab portions 186, 188.

The structure of the second substantially U-shaped bracket portion 142 will now be described in greater detail. The second substantially U-shaped bracket portion 142 includes first, second, and third wall portions 210, 212, 214 and first and second tab portions 216, 218. The first and second wall portions 210, 212 extend substantially parallel to the second axis 220 and are spaced apart from one another. The third wall portion 214 is coupled to and extends between a first end of the first wall portion 210 and a first end of the second wall portion 212. The first tab portion 216 extends from a second end of the first wall portion 210 substantially perpendicular to the first wall portion 210 and toward the second wall portion 212. The second tab portion 218 extends from a second end of the second wall portion 212 substantially perpendicular to the second wall portion 212 and toward the first wall portion 210 such that a first gap 224 is formed between the first and second tab portions 216, 218.

Referring to FIGS. 7 and 12, the first and second positioning tabs 144, 146 are provided to position the extruded mounting bracket 120 on the retaining bracket assembly 28. The first and second positioning tabs 144, 146 are spaced apart from one another and extend outwardly from the first substantially U-shaped bracket portion 140 substantially perpendicular to the first axis 90 and the first wall portion 180. The first and second positioning tabs 144, 146 extend along the entire length of the extruded mounting bracket 120 and define a positioning channel 181 therebetween.

Referring to FIGS. 8, 9 and 12, the extruded mounting bracket 120 is shaped to have an arcuate-shaped channel portion 160 and first and second leg portions 162, 164. Each of the arcuate-shaped channel portion 160 and the first and second leg portions 162, 164 has the first and second substantially U-shaped bracket portions 140, 142. The arcuate-shaped channel portion 160 has a first end 240 and a second end 242. The first leg portion 162 is integrally coupled to and extends from the first end 240 of the arcuate-shaped channel portion 160. The second leg portion 164 is integrally coupled to and extends from the second end 242 of the arcuate-shaped channel portion 160. Further, the first and second leg portions 162, 164 extend substantially parallel to one another. The arcuate-shaped channel portion 160 extends at least 180 degrees from the first end 240 to the second end 242 thereof.

Referring to FIGS. 5-12, the first plurality of bristles 122 are at least partially disposed in the first channel 192 of the first substantially U-shaped bracket portion 140 such that the first plurality of bristles 122 are coupled to the first substantially U-shaped bracket portion 140. The first plurality of bristles 122 extend outwardly from the first substantially U-shaped bracket portion 140 in a direction substantially parallel to the first axis 190. Further, the first plurality of bristles 122 extend from the arcuate-shaped channel portion 160, the first leg portion 162, and the second leg portion 164. In an exemplary embodiment, the first plurality of bristles 122 are constructed of nylon polypropylene.

The second plurality of bristles 124 are least partially disposed in the second channel 222 of the second substantially U-shaped bracket portion 142 such that the second plurality of bristles 124 are coupled to the second substantially U-shaped bracket portion 142. The second plurality of bristles 124 extend outwardly from the second substantially U-shaped bracket portion 142 in a direction substantially parallel to the second axis 220. Further, the second plurality of bristles 124 extend outwardly from the arcuate-shaped channel portion 160. In an exemplary embodiment, the second plurality of bristles 124 are constructed of nylon polypropylene.

Referring to FIGS. 4, 6, 16 and 17, the retaining bracket assembly 28 is provided to couple the brush assembly 26 to the debris removal assembly 22. The retaining bracket assembly 28 includes a retaining bracket 290, first and second retaining plates 292, 294 (shown in FIG. 4), and first and second thumbscrews 296, 298.

The retaining bracket 290 is configured to be coupled to the debris removal assembly 22. The retaining bracket 290 includes a first side wall 330, a second side wall 332, a top wall 334, a first tab 336, and a second tab 338.

The top wall 334 is coupled to and extends between the first and second side walls 330, 332. The first and second side walls 330, 332 extend substantially parallel to one another in a first direction. The first and second side walls 330, 332 and the top wall 334 define a substantially U-shaped retaining bracket 290. The first side wall 330 includes an outer side surface 370 and an inner surface 372. The second side wall 332 includes an outer side surface 390 and an inner surface 392. The top wall 334 includes a first outer side surface 420, a second outer side surface 422, a top surface 424, a front surface 426, and a rear surface 428. The top wall 334 includes apertures 440, 442 extending from the top surface 424 into the top wall 334. The top wall 334 further includes an aperture 444 extending from the top surface 424 to the front surface 426. The aperture 444 is configured to receive pressurized air therethrough for directing the debris from the welding tool 12 downwardly with respect to the retaining bracket assembly 28.

Referring to FIGS. 7, 12 and 16, the first tab 336 extends outwardly from the outer side surface 370 of the first side wall 330. Further, the second tab 338 extends outwardly from the outer side surface 390 of the second side wall 332. The first and second tabs 336, 338 are provided to position the extruded mounting bracket 120 on the retaining bracket 290. In particular, the extruded mounting bracket 120 is disposed on the retaining bracket 290 such that the first tab 336 of the retaining bracket 290 is disposed in a portion of the positioning channel 181 and the second tab 338 of the retaining bracket 290 is disposed in another portion of the positioning channel 181.

Referring to FIGS. 4 and 16, the first retaining plate 292 is provided to hold the extruded mounting bracket 120 on the retaining bracket 290. The first retaining plate 292 is coupled to the outer side surface 370 of the first side wall 330 of the retaining bracket 290 that abuts against an outer side surface of the extruded mounting bracket 120 utilizing the first thumb screw 296 to hold a portion of the extruded mounting bracket 120 against the first side wall 330 of the retaining bracket 290.

The second retaining plate 294 is provided to hold the extruded mounting bracket 120 on the retaining bracket 290. The second retaining plate 294 is coupled to the outer side surface 390 of the second side wall 332 of the retaining bracket 290 that abuts against an outer side surface of the extruded mounting bracket 120 utilizing the second thumb screw 298 to hold another portion of the extruded mounting bracket 120 against the second side wall 332 of the retaining bracket 290.

Referring to FIGS. 1, 4 and 6, the brush 29 is provided to cover a top portion of the interior region 128 of the brush assembly 26 for preventing debris from exiting the open top portion of the brush assembly 26. The brush 29 includes a plate 460 and a plurality of bristles 462 coupled to the plate 460. The plate 460 includes apertures 470, 472 extending therethrough. The thumb screws 475, 476 are disposed through the apertures 470, 472, respectively, of the plate 460 and the apertures 440, 442, respectively, in the mounting bracket 292 to couple the brush 29 to the mounting bracket 290.

Referring to FIGS. 1 and 4, the container coupling member 30 is provided to removably hold the collection container 32 thereon. The container coupling member 30 is coupled to the post 62 of the stand 20. The container coupling member 30 includes first and second plates 480, 482, finger portions 484, 486, and a mounting member 488. The mounting member 488 is coupled to the post 62 and is further coupled to the first plate 480. The first plate 480 extends substantially parallel to the post 62. The finger portions 484, 486 are coupled to a top end of the first plate 480 and extend generally downwardly with respect to the top end of the plate 480. The second plate 482 is coupled to the first plate 480 and extends substantially perpendicular to the first plate 482. The collection container 32 is disposed on the container coupling member 30 such that the finger portions 484, 486 engage an inner surface of the collection container 32, and a bottom surface of the collection container 32 is disposed on the second plate 482.

The collection container 32 is provided to collect debris 126 having copper particles that are removed from the welding tool 12 that fall downwardly from the interior region 128 (shown in FIG. 6) of the brush assembly 26. The collection container 32 includes a tubular wall 490 and a bottom wall 492 coupled to an end of the tubular wall 490. The collection 1032 further includes an interior region 493 configured to receive the debris 126 removed from the welding tool 12.

Referring to FIGS. 1, 4, 18 and 19, a flowchart of a method for blocking and collecting debris from the welding tool 12 in accordance with another exemplary embodiment is provided.

At step 500, a user provides the brush assembly 26 having the extruded mounting bracket 120, the first plurality of bristles 122, and the second plurality of bristles 124. The extruded mounting bracket 120 has first and second substantially U-shaped bracket portions 140, 142 integrally coupled together along a length of the extruded mounting bracket 120. The first and second substantially U-shaped bracket portions 140, 142 define first and second channels 192, 222, respectively, therein. The first substantially U-shaped bracket portion 140 has a first cross-sectional profile that is centered about a first axis 190 at a first position on the extruded mounting bracket 120. The second substantially U-shaped bracket portion 142 has a second cross-sectional profile that is centered about a second axis 220 at the first position on the extruded mounting bracket 120. The second axis 220 is disposed at an acute angle 0 relative to the first axis 190. An open end of the first substantially U-shaped bracket portion 140 is disposed distal from an open end of the second substantially U-shaped bracket portion 142. The extruded mounting bracket 120 is shaped to have an arcuate-shaped channel portion 160 and first and second leg portions 162, 164. Each of the arcuate-shaped channel portion 160 and the first and second leg portions 162, 164 has the first and second substantially U-shaped bracket portions 140, 142. The arcuate-shaped channel portion 160 has the first end 240 and the second end 242. The first leg portion 162 is integrally coupled to and extends from the first end 240 of the arcuate-shaped channel portion 160. The second leg portion 164 is integrally coupled to and extends from the second end 242 of the arcuate-shaped channel portion 160. The first plurality of bristles 122 are at least partially disposed in the first channel 192 of the first substantially U-shaped bracket portion 140 such that the first plurality of bristles 122 are coupled to the first substantially U-shaped bracket portion 140. The first plurality of bristles 122 extend outwardly from the first substantially U-shaped bracket portion 140 in a direction substantially parallel to the first axis 190. The second plurality of bristles 124 are at least partially disposed in the second channel 222 of the second substantially U-shaped bracket portion 142 such that the second plurality of bristles 124 are coupled to the second substantially U-shaped bracket portion 142. The second plurality of bristles 124 extend outwardly from the second substantially U-shaped bracket portion in a direction substantially parallel to the second axis 222. The first and second plurality of bristles 122, 124 define an interior region 128 (shown in FIG. 6).

At step 502, the robot 14 disposes the welding tool 12 the first plurality of bristles 122 into the interior region 128.

At step 504, the debris removal assembly 22 removes debris from the welding tool 12.

At step 506, the first and second plurality of bristles 122, 124 block the removed debris from moving outwardly past the first and second plurality of bristles 122, 124, and direct the debris downwardly toward the collection container 32.

At step 508, the collection container 32 collects the removed debris in an interior region of the collection container 32.

The brush assembly and the method described herein provide a substantial advantage over other assemblies and methods. In particular, the brush assembly and the method provide a technical effect of utilizing a brush assembly having an extruded mounting bracket holding a first plurality of bristles and a second plurality of bristles to block debris moving within an interior region from moving outwardly past the brush assembly.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

What is claimed is:

1. A brush assembly, comprising:
an extruded mounting bracket having first and second substantially U-shaped bracket portions integrally coupled together along an entire length of the extruded mounting bracket, the first and second substantially U-shaped bracket portions defining first and second channels, respectively, therein; the first substantially U-shaped bracket portion having a first cross-sectional profile that is centered about a first axis at a first position on the extruded mounting bracket, the second substantially U-shaped bracket portion having a second cross-sectional profile that is centered about a second axis at the first position on the extruded mounting bracket, the second axis being disposed at an acute angle relative to the first axis, an open end of the first substantially U-shaped bracket portion being disposed distal from an open end of the second substantially U-shaped bracket portion;
the extruded mounting bracket being shaped to have an arcuate-shaped channel portion and first and second leg portions, each of the arcuate-shaped channel portion and the first and second leg portions having the first and second substantially U-shaped bracket portions, the arcuate-shaped channel portion having a first end and a second end, the first leg portion being integrally coupled to and extending from the first end of the arcuate-shaped channel portion, the second leg portion being integrally coupled to and extending from the second end of the arcuate-shaped channel portion;
a first plurality of bristles being at least partially disposed in the first channel of the first substantially U-shaped bracket portion such that the first plurality of bristles are coupled to the first substantially U-shaped bracket portion, the first plurality of bristles extending outwardly from the first substantially U-shaped bracket portion in a direction substantially parallel to the first axis; and
a second plurality of bristles being at least partially disposed in the second channel of the second substantially U-shaped bracket portion such that the second plurality of bristles are coupled to the second substantially U-shaped bracket portion, the second plurality of bristles extending outwardly from the second substantially U-shaped bracket portion in a direction substantially parallel to the second axis.

2. The brush assembly of claim 1, wherein the first plurality of bristles extend outwardly from the first channel in the arcuate-shaped channel portion, the first leg portion, and the second leg portion.

3. The brush assembly of claim 2, wherein the second plurality of bristles extend outwardly from the second channel in the arcuate-shaped channel portion.

4. The brush assembly of claim 1, wherein the first and second leg portions extend substantially parallel to one another.

5. The brush assembly of claim 1, wherein the arcuate-shaped channel portion extends at least 180 degrees from the first end to the second end thereof.

6. The brush assembly of claim 1, wherein the first substantially U-shaped bracket portion has first, second, and third wall portions and first and second tab portions; the first and second wall portions extending substantially parallel to the first axis and being spaced apart from one another, the third wall portion being coupled to and extending between a first end of the first wall portion and a first end of the second wall portion, the first tab portion extending from a second end of the first wall portion substantially perpendicular to the first wall portion and toward the second wall portion, the second tab portion extending from a second end of the second wall portion substantially perpendicular to the second wall portion and toward the first wall portion such that a first gap is formed between the first and second tab portions.

7. The brush assembly of claim 6, wherein the second substantially U-shaped bracket portion has fourth, fifth, and sixth wall portions and third and fourth tab portions; the fourth and fifth wall portions extending substantially parallel to the second axis and being spaced apart from one another, the sixth wall portion being coupled to and extending between a first end of the fourth wall portion and a first end of the fifth wall portion, the third tab portion extending from a second end of the fourth wall portion substantially perpendicular to the fourth wall portion and toward the fifth wall portion, the fourth tab portion extending from a second end of the fifth wall portion substantially perpendicular to the fifth wall portion and toward the fourth wall portion such that a second gap is formed between the third and fourth tab portions.

8. A method for blocking debris from a welding tool, comprising:
providing a brush assembly having an extruded mounting bracket, a first plurality of bristles, and a second plurality of bristles; the extruded mounting bracket defining first and second substantially U-shaped bracket portions integrally coupled together along an entire length of the extruded mounting bracket, the first and second substantially U-shaped bracket portions defining first and second channels, respectively, therein; the first substantially U-shaped bracket portion having a first cross-sectional profile that is centered about a first axis at a first position on the extruded mounting bracket, the second substantially U-shaped bracket portion having a second cross-sectional profile that is centered about a second axis at the first position on the extruded mounting bracket, the second axis being disposed at an acute angle relative to the first axis, an open end of the first substantially U-shaped bracket portion being disposed distal from an open end of the second substantially U-shaped bracket portion;
the extruded mounting bracket being shaped to have an arcuate-shaped channel portion and first and second leg portions, each of the arcuate-shaped channel portion and the first and second leg portions having the first and second substantially U-shaped bracket portions, the arcuate-shaped channel portion having a first end and a second end, the first leg portion being integrally coupled to and extending from the first end of the arcuate-shaped channel portion, the second leg portion being integrally coupled to and extending from the second end of the arcuate-shaped channel portion;
the first plurality of bristles being at least partially disposed in the first channel of the first substantially U-shaped bracket portion such that the first plurality of bristles are coupled to the first substantially U-shaped bracket portion, the first plurality of bristles extending outwardly from the first substantially U-shaped bracket portion in a direction substantially parallel to the first axis; and
the second plurality of bristles being at least partially disposed in the second channel of the second substantially U-shaped bracket portion such that the second plurality of bristles are coupled to the second substantially U-shaped bracket portion, the second plurality of bristles extending outwardly from the second substantially U-shaped bracket portion in a direction substantially parallel to the second axis; the first and second plurality of bristles defining an interior region, the method further comprising:
blocking debris removed from the welding tool from moving outwardly past the first and second plurality of bristles utilizing the first and second plurality of bristles, and directing the debris downwardly from the brush assembly utilizing the first and second plurality of bristles.
